(19) United States
(12) Patent Application Publication
(10) Pub. No.: US 2024/0016125 A1
(43) Pub. Date: Jan. 18, 2024

(54) PET COLLAR WITH INTEGRATED LEASH

(71) Applicant: TUG PET PRODUCTS, LLC., Raleigh, NC (US)

(72) Inventors: Timothy NEAL, Toa Baja, PR (US); Zhichao YE, Shanghai (CN)

(73) Assignee: TUG PET PRODUCTS, LLC., Raleigh, NC (US)

(21) Appl. No.: 18/155,213

(22) Filed: Jan. 17, 2023

(30) Foreign Application Priority Data
Jul. 12, 2022 (CN) 202220110820.6

(51) Int. Cl. A01K 27/00

(52) U.S. Cl. CPC A01K 27/001

(57) ABSTRACT

An adjustable pet collar, including: a flexible collar strap, one end of the flexible collar strap is a buckle end, and the other end is movable; a first fastener, a second fastener, and a second buckle. The flexible collar is provided with a buckle structure that matches the buckle end; the movable end of the flexible collar belt passes through the first buckle and the second buckle one after another and then is fixed to the first buckle. The flexible collar belt includes: one end as a buckle The buckle end and the other end are movably connected to the first movable section of the first fastener, movably connected to the second movable section between the first fastener, and the second fastener, and one end is the movable end fixed to the first fastener and the other end is movably connected to the third movable section of the second fastener.

### FIELD

The embodiments relate to the technical field of pet supplies, in particular to dog harnesses and leashes.

### BACKGROUND

Pet ownership is increasing each year, especially pet dogs. Walking your dog outside most certainly requires a leash and is even mandated by many local governments. In certain environments, such as an enclosed dog park or neighborhood, a dog's leash will be temporarily removed.

With the threat of automobile traffic or an encounter with another animal, a pet owner needs the ability to control their dog quickly for everyone's safety. Most harnesses accomplish this with a stationary handle that can be grabbed quickly. The problem with the stationary handle is it is only a temporary solution until a pet owner can attach a leash to the harness. In most cases, depending on the dog's height, the stationary handle requires a pet owner to bend over while controlling their dog.

Therefore, this invention of a more convenient and practical integrated leash is the answer to this technical problem. The invention allows a dog owner to use the integrated leash with the harness and prevents users from hunching over while controlling their dog.

At present, conventional pet collars and their supporting pet leashes on the market usually have a fixed size or use elasticity for limited size adjustment. Such fixed-size pet collars cannot adapt to different breeds, sizes, or the same type of pets. The size of the pet's body changes at different growth times; if the elasticity of the material itself is used to adjust the size of the pet collar, its adjustment range is limited and cannot meet the needs of a larger range of size changes. In addition, it is easy to adjust the size by using the elasticity of the material itself. There was an accident that strangled a pet. However, the size adjustment structure of some pet collars in the prior art is relatively complicated, leading to increased operation and cost, and the adjustment structure is prone to failure and damage; in addition, traditional pet leashes usually cannot be conveniently stored in the pet at any time when the pet is not required. It is easy to cause accidents such as the entanglement of the pet leash when the pet is running around on the pet collar.

Therefore, the traditional pet collar cannot be adapted to pets of different types and sizes through a simple size adjustment structure, and the matching pet leash cannot be conveniently stored on the pet collar at any time without affecting the pet's activities is a technical problem to be solved urgently in this field.

### SUMMARY

The embodiments aim to solve the technical problem that the pet collar in the prior art cannot be adapted to pets of different types and sizes through a simple size adjustment structure, and the matching pet rope cannot be conveniently stored on the pet collar at any time without affecting the pet's activities. Provides an adjustable pet collar and pet rope especially suitable for dog traction.

To solve the above technical problems, the technical scheme adopted by these embodiments is:

An embodiment proposes an adjustable pet collar, which includes:

Flexible collar strap, one end of the flexible collar strap is the buckle end, and the other end is the movable end;

The first fastener and second fastener, the second fastener is provided with a buckle structure matching the buckle end;

The movable end of the flexible collar strap passes through the first fastener and the second fastener one after another and then is fixed to the first fastener. At this time, the flexible collar strap includes: one end as a buckle end and the other end is movably connected to the first fastener. The first movable section is movably connected to the second movable section between the first fastener and the second fastener, one end is fixed to the movable end of the first fastener, and the other end is movably connected to the third of the second fastener The movable section, the first movable section, and the third movable section cooperate with the buckle structure through the buckle end to form a movable collar for traction of pets.

Further, the first fastener includes a hollow first fastener frame, a first crossbar provided on the first fastener frame, and the first crossbar divides the hollow part of the first fastener frame into a pair of the first holes;

The second fastener includes: a hollow second fastener frame, a second crossbar provided on the second fastener frame, the second crossbar divides the hollow part of the second fastener frame into a pair of second through holes, and the buckle structure on the second buckle frame.

Further, the movable end is inserted between the pair of first through holes from one side of the first crossbar, and the first fastener is inserted on the flexible collar strap, and the flexible collar strap is connected to the first buckle at the buckle end. The first movable section with movable adjustable length is formed between the pieces;

After the movable end passes through the first fastener, the movable end is inserted between the pair of second through holes from one side of the second crossbar, and the second fastener is inserted on the flexible collar strap. The flexible collar strap A second movable section with movable and adjustable length is formed between the first fastener and the second fastener;

After the movable end passes through the second fastener, the movable end is inserted between the pair of first through holes from one side of the first crossbar, and the flexible collar strap forms a flexible collar between the second fastener and the first fastener. The length of the third movable section can be adjusted, and the movable end is finally fixed to the third movable section to form a first loop that sleeves the movable end on the first crossbar.

Preferably, the first movable section is provided with a raised limit layer on the surface of the flexible collar band, and the minimum length of the first movable section is restricted by the cooperation of the limit layer and the first fastener.

Further, it also includes:

Telescopic traction rope; the first movable section is also provided with a buckle, and the telescopic traction rope can be bound to the buckle.

Further, the telescopic traction rope includes:

An elastically stretchable traction section and a graspable hand-held section, one end of the traction section is fixedly connected to the hand-held section;

The buckle includes: a hollow ring-shaped main body, a third crossbar connected to the middle of the ring-shaped main body, the third crossbar divides the hollow part of the ring main body into a pair of third through holes;

The buckle end passes through one of the third through-holes, and the buckle is inserted on the flexible collar strap;

The other end of the traction section is provided with a connecting belt. The end of the connecting belt passes through the other third through-hole. After the end of the connecting belt passes through the other third through-hole, the end of the connecting belt is fixed to the connecting belt. And a second loop is formed to sleeve the connecting belt on the ring-shaped main body.

Further, it also includes a card slot structure that matches the buckle structure. The card slot structure includes a card slot insert frame. A fourth through hole is formed between the frames;

The buckle end passes through one of the third through-holes and then through the fourth through-hole, and the buckle structure is inserted into the flexible collar strap;

After the buckle end passes through the fourth through-hole, the buckle end is fixed to the first movable section, and a third loop is formed to wrap the flexible collar strap on the fourth crossbar, and the ring body is passed through the first movable section. The fourth ring is on a movable section.

Further, at least one movable magnetic attraction structure is provided on the second movable section, and the movable magnetic attraction structure includes: a sliding seat that can reciprocally slide along the second movable section, and a first magnet installed on the sliding seat;

The hand-held section includes: a pair of flexible handle straps, one end of the pair of flexible handle straps is respectively corresponding to the fixed magnetic base installed at one end of the traction section, and the other ends of the pair of flexible handle straps are correspondingly connected so that the pair of flexible handles The belt constitutes a flexible handle that can be held; and the other end of the pair of flexible handle belts is equipped with a second magnet that can attract the first magnet at the corresponding junction and/or the fixed magnetic base; The two magnets attract each other, and the hand-held section can be absorbed and stored in the second movable section.

Furthermore, the second movable section is provided with two movable magnetic attraction structures, and a second magnet capable of attracting the first magnet is installed at the corresponding junction of the other ends of the pair of flexible handle straps and the fixed magnetic attraction seat.

Preferably, the traction section is made of a retractable belt rope, and the inner side of the flexible handle is provided with a non-slip lining.

Compared with the prior art, the pet collar provided by the present invention can be adapted to pets of different types and sizes through a simple size adjustment structure, and its supporting pet leash can be conveniently and conveniently stored on the collar at any time without affecting pet activities. An embodiment relates to an adjustable pet collar which is especially suitable for dog traction and integrated with a pet rope.

### BRIEF DESCRIPTION OF THE DRAWINGS

To explain the technical solutions in the embodiments more clearly, the following will briefly introduce the drawings that need to be used in the description of the embodiments or the prior art.

The drawings in the following description are only for the utility model. For some of the new embodiments, those of ordinary skill in the art can obtain other drawings based on these drawings without creative labor.

FIG. 1 is a schematic diagram of the assembly structure of an adjustable pet collar in an embodiment.

FIG. 2 is a zoomed in view of a portion of an adjustable pet collar.

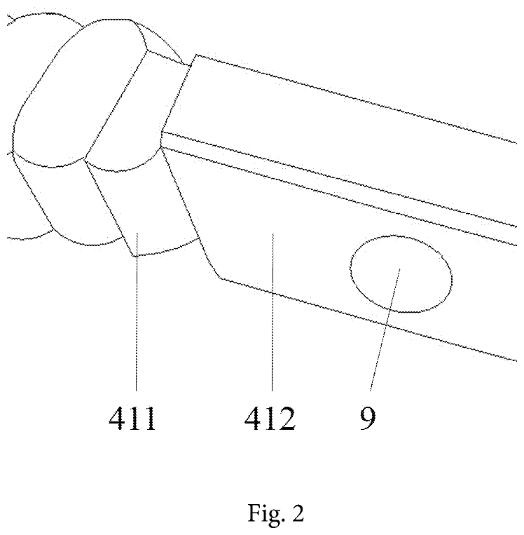

FIG. 3 is another zoomed in view of a portion of an adjustable pet collar.

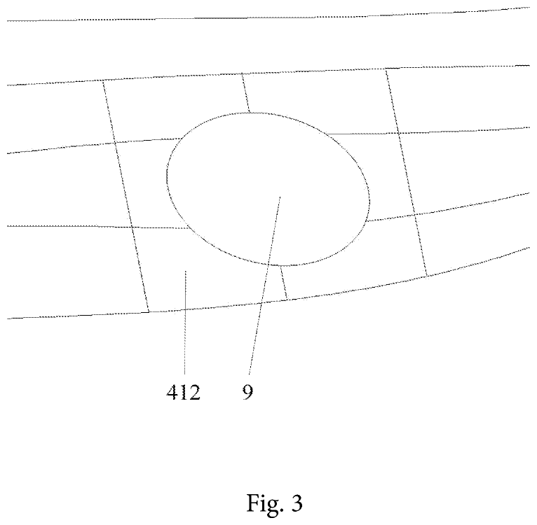

### DETAILED DESCRIPTION

To make the technical problems, technical solutions and beneficial effects to be solved by the present embodiments clearer, the embodiments will be further described in detail below regarding accompanying drawings 1 and embodiments. It should be understood that the specific embodiments described here are only used to explain the embodiments, and are not used to limit the embodiments.

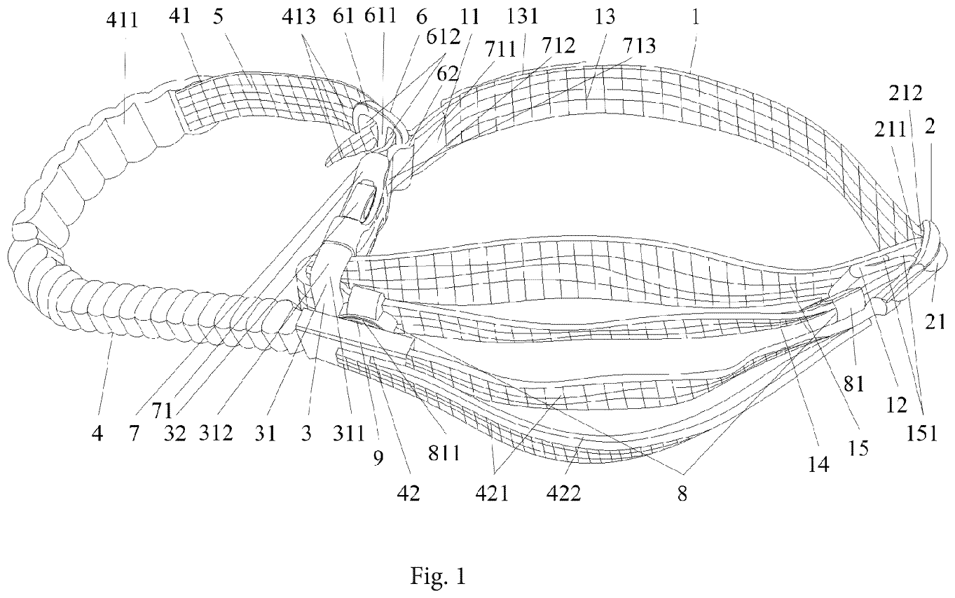

The principle and structure of the embodiments will be described in detail below regarding FIG. 1 and embodiments.

Please refer to FIG. 1. The adjustable pet collar provided by the embodiments includes:

A flexible collar strap 1, one end of the flexible collar strap 1 is a buckle end 11, which is used to set the clamping structure 7; the other end is a movable end 12, which is used to pass through other parts of the pet collar; the first fastener 2, The second fastener 3 is provided with a buckle structure 32 that matches the buckle structure 7 of the buckle end 11;

The movable end 12 of the flexible collar strap 1 passes through the first fastener 2 and the second fastener 3 and then is fixed to the first fastener 2. At this time, the flexible collar strap 1 includes: one end is a buckle end 11, and the other end is movable The first movable section 13 connected to the first fastener 2 is movably connected to the second movable section 14 between the first fastener 2 and the second fastener 3, and one end is the movable end 12 fixed to the first fastener 2 And the other end is movably connected to the third movable section 15 of the second fastener 3. The first movable section 13 and the third movable section 15 cooperate with the buckle structure 32 through the buckle end 11 to form a movable collar for the traction of pets.

In this embodiment, the first fastener 2 includes: a hollow first fastener 2 frame, a first crossbar 211 arranged on the first fastener 2 frame, and the first crossbar 211 connects the frame of the first fastener 2 The hollow part is divided into a pair of first through holes 212; the second fastener 3 includes a hollow second fastener frame 31, a second crossbar 311 arranged on the second fastener frame 31, and the second crossbar 311 connects the first The hollow part of the two fastener frames 31 is divided into a pair of second through holes 312, and the buckle structure 32 is provided on the second fastener frame 31.

In this embodiment, the movable end 12 is inserted between a pair of first through holes 212 from one side of the first crossbar 211, and the first fastener 2 is inserted on the flexible collar band 1, and the flexible collar band 1 Between the buckle end 11 and the first fastener 2, a first movable section 13 whose length can be movably adjusted by the first fastener 2 and the flexible collar strap 1 sliding against each other is formed;

After the movable end 12 passes through the first fastener 2, the movable end 12 is inserted between the pair of second through holes 312 from one side of the second crossbar 311, and the second fastener 3 is inserted through the flexible collar On the belt 1, the flexible collar belt 1 is formed between the first fastener 2 and the second fastener 3, so that the first fastener 2 and the flexible collar belt 1, the second fastener 3 and the flexible collar belt 1 respectively correspond to The second movable section 14 that slides to move to adjust the length;

After the movable end 12 passes through the second fastener 3, the movable end 12 is inserted between the pair of first through holes 212 from one side of the first crossbar 211, and the flexible collar strap 1 is placed between the second fastener 3 and the second fastener 3 Between one fastener 2, a third movable section 15 is formed which can be movably adjusted in length by sliding the second fastener 3 and the flexible collar strap 1 to each other. Finally, the movable end 12 is fixed to the third movable section 15 to form a movable end 12 The first collar 151 set on the first crossbar 211 (here the first collar 151 is fixed to the first crossbar 211 of the first fastener 2, so here the first fastener 2 and the flexible collar strap 1 Can not slide between each other).

As a preferred embodiment, the first movable section 13 is provided with a raised limit layer 131 on the surface of the flexible collar band 1, and when the limit layer 131 contacts the first fastener 2, the first movable section 13 (flexible collar band 1) The sliding with the first fastener 2 realizes the limit cooperation, to realize the restriction on the minimum length of the first movable section 13.

In this embodiment further includes: a telescopic traction rope 4; the first movable section 13 is also provided with a buckle 6, and the telescopic traction rope 4 can be bound to the buckle 6. Specifically, the retractable traction rope 4 includes: an elastically retractable traction section 41 and a graspable hand-held section 42. One end of the traction section 41 is fixedly connected to the hand-held section 42; the buckle 6 includes: a hollow ring-shaped body 61, A third crossbar 611 connected to the middle of the ring body 61, the third crossbar 611 divides the hollow part of the ring body 61 into a pair of third through holes 612; the buckle end 11 passes through one of the third through holes 612, And pierce the buckle 6 on the flexible collar strap 1; the other end of the traction section 41 is provided with a connecting strap 5, the end of the connecting strap 5 passes through the other third through hole 612, and the end of the connecting strap 5 is from After the other third through hole 612 is penetrated, the end of the connecting strap 5 is fixed to the connecting strap 5 and a second loop 413 is formed to sleeve the connecting strap 5 on the annular main body 61.

This embodiment further includes a card slot structure that matches the buckle structure 32. The card slot structure includes a card slot insert frame 71. One end of the card slot insert frame 71 is provided with a fourth crossbar 711. A fourth through hole 712 is formed between the crossbar 711 and the slot insertion frame 71; the buckle end 11 passes through one of the third through holes 612 and then passes through the fourth through hole 712, and the slot structure is inserted into the flexible collar Belt 1; after the buckle end 11 passes through the fourth through hole 712, the buckle end 11 is fixed to the first movable section 13, and forms a third set of flexible collar belt 1 sleeved on the fourth crossbar 711 The ring 713 and the fourth collar 62 that pierces the ring-shaped body 61 on the first movable section 13.

In this embodiment, the second movable section 14 is provided with at least one movable magnetic attraction structure 8. The movable magnetic attraction structure 8 includes: a sliding seat 81 that can reciprocally slide along the second movable section 14, and a sliding seat 81 mounted on the sliding seat 81 The first magnet 811; the hand-held section 42 includes: a pair of flexible handle straps 421, one end of the pair of flexible handle straps 421 is respectively installed on a fixed magnetic base provided at one end of the traction section 41, the other of the pair of flexible handle straps 421 One end is correspondingly connected, so that the pair of flexible handle straps 421 constitute a flexible handle that can be held; and the other end of the pair of flexible handle straps 421 corresponds to the joint and/or the fixed magnetic base is installed with the first magnet 811 The second magnet 9 that attracts each other; through the first magnet 811 and the second magnet 9 are attracted, the hand-held section 42 can be attracted and stored in the second movable section 14.

As a preferred embodiment, the second movable section 14 is provided with two (a pair of) movable magnetic structures 8, and the other end of the pair of flexible handle straps 421 and the fixed magnetic seat are both installed to be able to connect with the first A second magnet 9 attracted by a magnet 811. A pair of movable magnetic structures 8 can be adapted to adjust the length of the second movable section 14 and slide back and forth on the flexible collar band 1. The hand-held section 42 of the telescopic traction rope 4 can be adsorbed to the first part of the flexible collar band 1 through the second magnet 9 On magnet 811, when a pet such as a pet dog wants to run freely, the magnetic attraction function makes the retractable leash 4 more convenient and faster to be put back on the collar, which is convenient for the user and improves the user experience.

As a preferred embodiment, the first magnet 811 and the second magnet 9 can be covered with fabric and stitched, to be hidden under the surface of the flexible collar band 1 without being exposed.

As another embodiment, the first magnet 811 and the second magnet 9 can be replaced by magnetic tape.

As a preferred embodiment, the traction section 41 is made of a retractable belt cord 411, and a non-slip lining 422 is provided on the inside of the flexible handle. The retractable elasticity made of the belt rope 411 gives the retractable traction rope 4 extra

What is claimed:

1. An adjustable pet collar, comprising:
a flexible collar strap, one end of the flexible collar strap is the buckle end, and the other end is the movable end;
a first fastener and a second fastener, the second fastener is provided with a buckle structure that matches the buckle end; and
the movable end of the flexible collar strap passes through the first fastener and the second fastener one after another and then is fixed to the first fastener; the flexible collar strap is movably connected to the first movable section of the first fastener, movably connected to the second movable section between the first fastener and the second fastener, and one end of the flexible collar strap is fixed to the first movable section; the movable end of a fastener and the other end are movably connected to the third movable section of the second fastener, and the first movable section and the third movable section are connected to the card through the buckle end The buckle structure cooperates to form an active collar for leaning pets.

2. The adjustable pet collar of claim 1, wherein:
the first fastener includes: a hollow first fastener frame, a first crossbar provided on the first fastener frame, and the first crossbar separates the hollow part of the first fastener frame Form a pair of first-through holes; and
the second fastener includes a hollow second fastener frame, a second crossbar provided on the second fastener frame, and the second crossbar separates the hollow part of the second fastener frame A pair of second through holes are formed on the buckle structure on the second buckle frame.

3. The adjustable pet collar of claim 2, wherein:
the movable end is inserted between a pair of the first through holes from one side of the first crossbar, and the first fastener is inserted on the flexible collar strap, the belt forms the first movable section of movable adjustable length between the buckle end and the first fastener;
after the movable end passes through the first fastener, the movable end penetrates between the pair of second through holes from one side of the second crossbar and connects the second fastener, a piece is passed on the flexible collar strap, and the flexible collar strap forms the second movable section with a movable adjustable length between the first fastener and the second fastener; and
after the movable end passes through the second fastener, the movable end penetrates between a pair of the first through holes from one side of the first crossbar, and the flexible collar straps; the third movable section with movable adjustable length is formed between the second fastener and the first fastener, and the movable end is fixed to the third movable section to form a sleeve for the movable end on the first collar on the first crossbar.

4. The adjustable pet collar of claim 3, wherein the first movable section is provided with a raised limit layer on the surface of the flexible collar band and passes through the limit layer and the first buckle and pieces cooperate to realize the restriction on the minimum length of the first movable section.

5. The adjustable pet collar according to claim 1, further comprising:
a telescopic traction rope; the first movable section is also provided with a buckle, and the telescopic traction rope can be bound to the buckle.

6. The adjustable pet collar of claim 5, wherein:
the telescopic traction rope includes:
an elastically stretchable traction section and a graspable hand-held section, and one end of the traction section is fixedly connected to the hand-held section;
the buckle includes a hollow ring-shaped body, and a third crossbar connected to the middle of the ring-shaped body, the third crossbar divides the hollow part of the ring-shaped body into a pair of third through holes;
the buckle end passes through one of the third through-holes, and the buckle is inserted on the flexible collar strap; and
the other end of the traction section is provided with a connecting belt, the end of the connecting belt passes through the other of the third through-holes, and the end of the connecting belt passes through the other of the third through-holes; and the end of the connecting strap is fixed to the connecting strap and forms a second loop that sleeves the connecting strap on the annular body.

7. The adjustable pet collar of claim 6, further comprising: a slot structure matching the buckle structure, the slot structure comprising: a slot insert frame, the slot insert frame, a fourth cross bar is provided at one end, and a fourth through hole is formed between the fourth crossbar and the slot insertion frame;
the buckle end passes through one of the third through holes and then passes through the fourth through-hole, and the buckle structure is inserted into the flexible collar strap;
after the buckle end passes through the fourth through-hole, the buckle end is fixed to the first movable section and forms a fourth crossbar that sleeves the flexible collar strap on the fourth crossbar, and three sets of rings and a fourth set of rings pierce the ring-shaped body on the first movable section.

8. The adjustable pet collar of claim 6, wherein the second movable section is provided with at least one movable magnetic attraction structure, and the movable magnetic attraction structure comprises: reciprocating along the second movable section sliding seat, a first magnet installed on the sliding seat;
the hand-held section includes a pair of flexible handle straps; one end of the pair of flexible handle straps corresponds to a fixed magnetic base installed at one end of the traction section; the other ends of the pair of flexible handle straps are connected so that the pair; the flexible handle strap comprises a flexible handle that can be held, and the corresponding junction of the other ends of the pair of flexible handle straps and/or the fixed magnetic base is installed with a second magnet that can attract the first magnet; and through the attraction of the first magnet and the second magnet, the hand-held section can be attracted and stored in the second movable section.

9. The adjustable pet collar according to claim 8, wherein the second movable section is provided with two movable magnetic structures, and the other ends of a pair of flexible handle straps correspond to the joint and the position; and the fixed magnetic attraction seat is equipped with a second magnet that can attract the first magnet.

10. The adjustable pet collar of claim 8, wherein the traction section is made of a retractable belt cord, and an anti-slip lining is provided on the inner side of the flexible handle.
